(19) United States
(12) Patent Application Publication
(10) Pub. No.: US 2004/0168876 A1
(43) Pub. Date: Sep. 2, 2004

(54) Spring clutch

(76) Inventors: Thomas L. Tully, Oxford, CT (US); Ruth H. Durwin, Sandy Hook, CT (US); Charles J. Isabelle, Barkhamsted, CT (US); Robert T. Bohm, Monroe, CT (US); Robert J. Durwin, Trumbull, CT (US)

Correspondence Address: BACHMAN & LAPOINTE, P.C., 900 CHAPEL STREET, SUITE 1201, NEW HAVEN, CT, 06510, US

(21) Appl. No.: 10/376,142

(22) Filed: Feb. 28, 2003

(51) Int. Cl. F16D 41/20; F16F 1/10

(52) U.S. Cl. 192/41 S; 192/75

(57) ABSTRACT

A spring clutch has a housing containing first and second sleeves surrounding first and second longitudinal spans of a coil spring. A carrier mounting at least one of the sleeves relative to the housing flexes to maintain alignment of axes of the sleeves to control forces on the portion of the spring spanning the gap between the sleeves.

### U.S. GOVERNMENT RIGHTS

The invention was made with U.S. Government support under contract DAAH10-01-2-0032 awarded by the U.S. Army. The U.S. Government has certain rights in the invention.

### BACKGROUND OF THE INVENTION

(1) Field of the Invention

This invention relates to power transmission, and more particularly to spring clutches.

(2) Description of the Related Art

Overrunning spring clutches are a well developed art. Such clutches make use of the principle that a spring coil will expand if twisted one way about its axis and contract if twisted the other way. In an exemplary clutch, respective portions of a coil spring are positioned within respective sleeves. In a neutral condition, of the spring portion within each sleeve, an end portion is lightly frictional engaged to the sleeve and a remaining portion is slightly radially spaced from the sleeve. When the sleeves rotate relative to each other about their common axis, friction between the sleeves and the associated end portions will tend to twist the spring. If the relative rotation is in the direction which would tend to contract the spring, there will be slippage or overrunning. If the relative rotation is in the opposite direction, the normal forces between the end portions and sleeve will increase and the heretofore spaced portions will expand into frictional engagement with the sleeves thereby resisting the relative rotation. Accordingly, when such a clutch is used to drive an output from an input rotating (absolutely) in a first direction, the clutch permits the output to rotate faster than the input in the first direction. This permits the output to continue to rotate if the input slows or is stopped. Absolute rotation of the input (or both the input and output) in an opposite second direction may be prevented by additional internal or external mechanisms.

U.S. Pat. No. 5,799,931 (the '931 patent, the disclosure of which is incorporated by reference herein as if set forth at length) discloses an exemplary such spring clutch. In that patent, the spring is formed into a coil by a machining a helical slot in a tubular form (e.g., as distinguished from winding a wire or somehow casting without machining a slot).

### BRIEF SUMMARY OF THE INVENTION

Accordingly, in one aspect the invention is directed to a spring clutch apparatus. The spring has a central longitudinal axis and first and second axial ends. First and second sleeves surround first and second longitudinal spans of the spring. A first bearing supports the first sleeve for rotation relative to a housing about a first axis normally coincident with the spring axis. A sleeve carrier at least partially surrounds the second sleeve and has first and second portions and an intermediate portion therebetween. A first portion is secured relative to the housing and the second portion is relatively radially movable relative to the housing with a flexing of the intermediate portion. A second bearing system supports the second sleeve for rotation relative to the sleeve carrier second portion about a second axis coincident with the spring axis and with the first axis when the sleeve carrier intermediate portion is in an unflexed condition. The sleeves engage the spring so that initial relative rotation between the first and second sleeves in a first direction tends to uncoil the spring and bias the spring into firmer engagement with the sleeves. Initial relative rotation between the sleeves in a second direction, opposite the first direction, tends not to uncoil the spring.

In various implementations, a pinion gear may be unitarily formed with the first sleeve. The first bearing may be positioned radially between the first sleeve and the housing. An arbor may extend through the sleeves and be secured against rotation relative to the second sleeve. The sleeve carrier may have a circumferential array of elongate slots. The slots may extend longitudinally and have relatively wide central portions tapering toward first and second ends. The slots may extend longitudinally and at central portions may be wider than intervening unslotted portions of the carrier. The slots may be through-slots between interior and exterior surfaces of the carrier.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a longitudinal, partially sectional, view of a clutch according to principles of the invention.

FIG. 2 is a longitudinal cutaway view of an input housing assembly of the clutch of FIG. 1.

Like reference numbers and designations in the various drawings indicate like elements.

### DETAILED DESCRIPTION

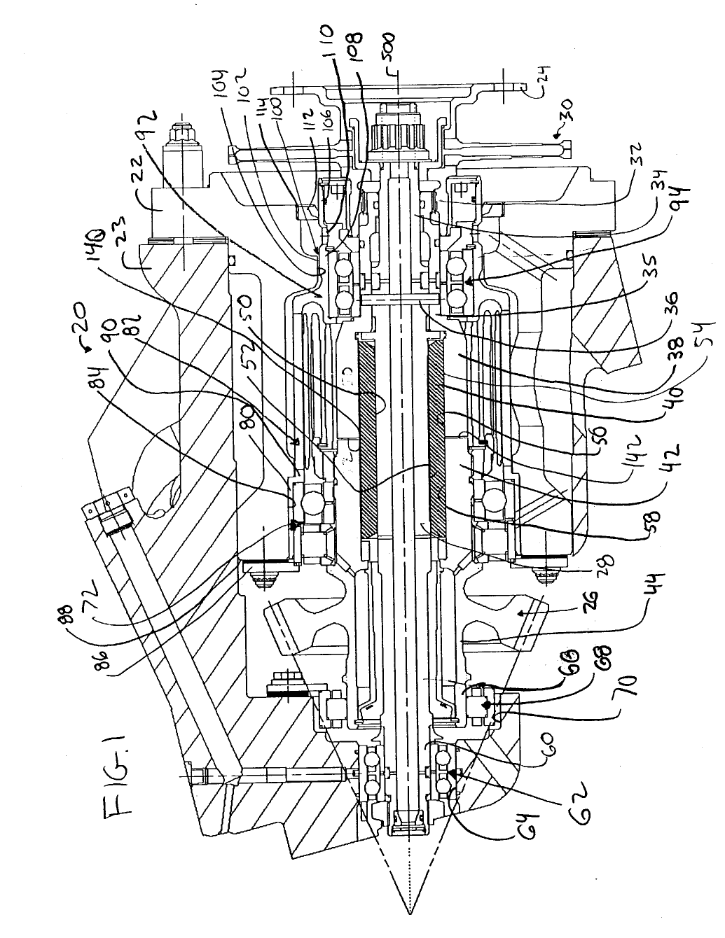

FIG. 1 shows a spring clutch 20 having an input housing 22 with a central longitudinal axis 500. The input housing 22 is itself mounted within a main housing 23 (e.g., a gearbox housing). The clutch receives a driving torque about the axis 500 from an external source (e.g., an engine (not shown)) through an input drive flange 24. The clutch may transmit a first sense or direction of such torque to an external load (e.g., a helicopter rotor system (not shown)) through an output pinion gear 26. The clutch advantageously does not transmit substantial torque of an opposite sense. Accordingly, input rotation in a first direction will be transmitted as output rotation, although the output pinion gear may rotate faster in that direction in an overrunning condition. Opposite input rotation (if permitted) will not be so transmitted to the output pinion gear.

In the illustrated embodiment, the input drive flange 24 drives an arbor shaft 28 via a diaphragm coupling 30. The arbor shaft has an axis normally coincident with the input housing axis 500. Specifically, the flange is secured to one end of the coupling while the other end is secured to an outer collar 32. The outer collar 32 surrounds and engages an upstream or input end collar portion 34 of a sleeve member 35 via interfitting teeth. The collar portion 34 surrounds a portion of the arbor shaft 28 and is secured thereto against relative rotation by a pin 36.

The sleeve member 35 further includes a downstream sleeve portion 38 surrounding an upstream portion of a spring 40. A downstream portion of the spring 40 is surrounded by an upstream sleeve portion 42 unitarily formed with a root collar 44 of the pinion gear 26 downstream thereof. The sleeve portions 38 and 42 and spring each have central longitudinal axes normally coincident with the axis 500. The illustrated spring 40 has an interior surface 50 surrounding and in facing or contacting close proximity to an exterior surface 52 of a central portion of the arbor. The spring has an exterior surface 54 along its respective upstream and downstream portions in close facing or contacting proximity to interior surfaces 56 and 58 of the sleeve portions 38 and 42. The spring 40 may be constructed, for example, as in the '931 patent so that when the input flange 24 (and thus the sleeve portion 38) is rotated in a first direction about the axis 500 torque and rotation will be transmitted to the pinion gear 26. When rotated in the opposite direction, such torque and rotation will substantially not be transferred. Similarly, if the pinion gear 26 is externally rotated in the first direction (such as by additional engine input) such rotation will substantially not be transferred to the input flange 24.

A series of bearings may mount the various rotatable components for rotation relative to the main and input housings. In the exemplary embodiment, a downstream end portion 60 of the arbor shaft is rotatably mounted relative to the main housing by a duplex ball bearing system 62 mounted in a pocket 64 in the main housing. A downstream portion 66 of the pinion gear root collar 44 is also mounted to the main housing via a roller bearing system 68 in a housing compartment 70 upstream and radially outboard from the compartment 64. The sleeve portion 42 of the pinion gear is mounted to the input housing 22 via a duplex roller/ball bearing system 72. In the exemplary embodiment, the outer races of the ball bearing system 72 are held within a downstream portion 80 of a carrier 82. The downstream portion 80 is mounted by press fit within a downstream compartment 84 of the input housing. The outer races of the bearing system 72 are longitudinally held in place between clips 86 secured to the downstream rim 88 of the input housing and a downstream-facing shoulder portion 90 of the carrier.

An upstream portion 92 of the carrier carries an outer race of a duplex roller bearing system 94. The inner race engages the outer surface of the collar portion 34 to rotatably mount the sleeve member 35 to the carrier upstream portion for rotation about an axis of the bearing system 94 normally coincident with the axis 500. In the exemplary embodiment, there is a radial gap 100 between an outboard surface portion 102 of the carrier upstream portion 92 and an adjacent inboard surface 104 of the input housing 22. This radial gap permits a limited local radial excursion of the carrier upstream portion 92, bearing system 94, collar portion 34 and adjacent arbor portion. The carrier upstream portion 92 includes an upstream end portion 106 separated from a main portion 108 by an intermediate portion 110 having a circumferential array of apertures. A lip seal 112 mounted in an upstream-open compartment 114 of the input housing seals with the outboard surface of the end portion 106.

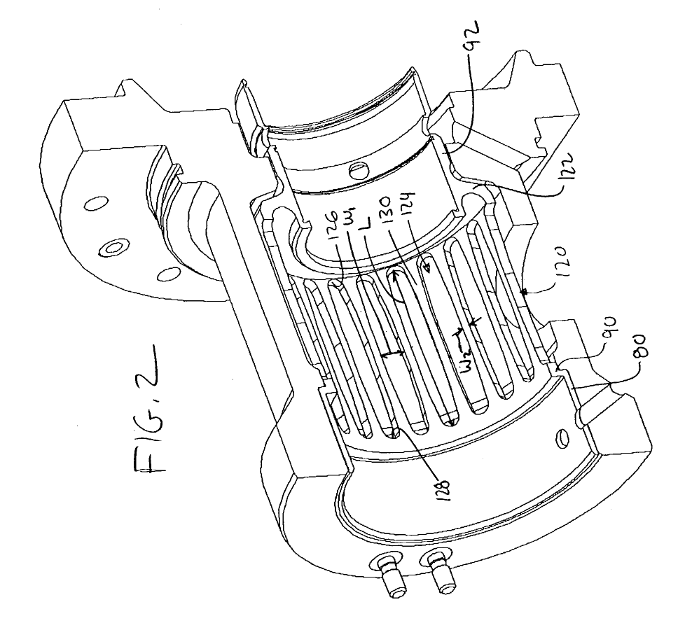

FIG. 2 shows further details of the carrier 82. A central portion 120 extends upstream from the shoulder 90 at a slightly smaller diameter than the downstream portion 80. A second shoulder 122 joins the upstream end of the central portion 120 to the main portion 108 of the upstream portion 92 slightly upstream of a downstream rim thereof. The central portion 120 is made relatively flexible by the inclusion of a circumferential array of longitudinally-extending slots 124 having upstream and downstream ends 126 and 128 respectively. The slots have lengths L and maximum widths W₁ at their longitudinal midpoints. Between each pair of adjacent slots, an unslotted portion 130 provides a longitudinally-extending web or beam between the shoulders 90 and 122. Near their midpoints, the beams have a width W₂ which, for flexibility, are advantageously smaller than the slot widths W₁. The carrier may be made flexible by alternate means such as by a general thinning of material in the absence of slots or a local thinning of material (e.g., blind slots).

The flexibility of the central portion 120 permits a radial and/or angular excursion of the carrier upstream portion 92 (and thus the bearing system 94, sleeve member 35, local portion of the arbor 28, and their locally common axis) relative to the input housing axis 500. In operation, loads on the pinion gear can produce a combination of flexing of the main housing and input housing, arbor shaft, and pinion gear. Were the outer race of the bearing system 94 rigidly mounted to the input housing without play, the flexing could cause an undesired degree of misalignment of the sleeve portions 38 and 42 causing their local axes and respective longitudinally inboard rims 140 and 142 to become radially and/or angularly misaligned. This misalignment might place substantial stress on the central portion of the spring spanning the gap between the sleeve portions. In the exemplary embodiment, the flexing still transmits a deflection force across the central portion of the spring. However when this force is, in turn, transmitted to the sleeve portion 38, the carrier central portion flexes, permitting a partial realignment of the carrier portion 38 relative to the carrier portion 40. Thus transmission of the misalignment to the sleeves is controlled/attenuated as are the misalignment forces encountered by the spring. The magnitude of the radial clearance 100 may limit the range of carrier flexing.

The clearance 100 may be selected so that a predetermined misalignment may be accommodated without contacting the surfaces 102 and 104. The clearance should not be so great as to permit overstressing of the carrier central portion 120. The effective spring rate in flexion of the carrier is influenced by factors such as the slot size and geometry, the number of slots, and the thickness of the local unslotted material. The spring rate may advantageously be selected to be soft or low enough so that expected deflection forces will permit the desired realignment while not being so soft that the system will become dynamically excited during normal operation. The lip seal should have sufficient compliance to accommodate the flexing while maintaining sealing effectiveness to prevent loss of oil.

One or more embodiments of the present invention have been described. Nevertheless, it will be understood that various modifications may be made without departing from the spirit and scope of the invention. For example, in various embodiments or uses, the input and output may be through the arbor rather than the sleeve. Also, the invention may be applied to various spring and clutch configurations both known and yet developed. Details of any particular application (e.g., the environment in which the clutch is used) may influence the structure of such implementation. Accordingly, other embodiments are within the scope of the following claims.

What is claimed is:

1. A clutch apparatus comprising:
a spring having a central longitudinal axis and first and second axial ends;
a first sleeve, surrounding a first longitudinal span of the spring;
a second sleeve, surrounding a second longitudinal span of the spring;
a housing;
a first bearing, supporting the first sleeve for rotation relative to the housing about a first axis normally coincident with the spring axis;
a sleeve carrier at least partially surrounding the second sleeve and having first and second portions and an intermediate portion therebetween, the first portion being secured relative to the housing and the second portion being relatively radially moveable relative to the housing with a flexing of the intermediate portion; and
a second bearing system, supporting the second sleeve for rotation relative to the sleeve carrier second portion about a second axis coincident with the spring axis and the first axis when the sleeve carrier intermediate portion is in an unflexed condition,
wherein the first and second sleeves engage the spring so that:
initial relative rotation between the first and second sleeves in a first direction tends to uncoil the spring and bias the spring into firmer engagement with the first and second sleeves; and
initial relative rotation between the first and second sleeves in a second direction, opposite the first direction, tends not to uncoil the spring.

2. The clutch apparatus of claim 1 further comprising a pinion gear unitarily formed with the first sleeve.

3. The clutch apparatus of claim 1 wherein the first bearing is positioned radially between the first sleeve and the housing.

4. The clutch apparatus of claim 1 further comprising an arbor extending through the first sleeve and the second sleeve and secured against rotation relative to the second sleeve.

5. The clutch apparatus of claim 1 wherein the sleeve carrier has a circumferential array of slots.

6. The clutch apparatus of claim 5 wherein the slots extend longitudinally and have relatively wide central portions, tapering toward first and second ends.

7. The clutch of claim 5 wherein the slots extend longitudinally and at central portions are wider than intervening unslotted portions of the carrier.

8. The clutch apparatus of claim 5 wherein the slots are through-slots between interior and exterior surfaces of the carrier.

9. A clutch apparatus comprising:
a spring having a central longitudinal spring axis and first and second axial ends;
a housing;
a first sleeve, surrounding a first longitudinal span of the spring and held for rotation relative to the housing about a first axis normally coincident with the spring axis;
a second sleeve, surrounding a second longitudinal span of the spring and held for rotation relative to the housing about a second axis coincident with the spring axis and the first axis and having a longitudinally inboard end facing a longitudinally inboard end of the first sleeve and wherein the first and second sleeves engage the spring so that:
initial relative rotation between the first and second sleeves in a first direction tends to uncoil the spring and bias the spring into firmer engagement with the first and second sleeves; and
initial relative rotation between the first and second sleeves in a second direction, opposite the first direction, tends not to uncoil the spring;
an arbor coupled to one of the first and second sleeves against relative rotation;
a gear coupled to the other of the first and second sleeves to resist relative rotation; and
carrier means for mounting at least one of the first and second sleeves to attenuate the transmission of misalignment of axes of the arbor and gear to misalignment of the longitudinally inboard ends of the first and second sleeves.

10. The clutch apparatus of claim 9 wherein:
said one of the first and second sleeves is the second sleeve and said other is the first sleeve;
the arbor has a first end protruding from the first sleeve and mounted to the housing by a first bearing system;
the first sleeve is mounted to the housing by a second bearing system; and
the second sleeve is mounted to the carrier means by a third bearing system.

11. The clutch apparatus of claim 9 wherein:
the housing comprises a main housing and a secondary housing removeably mounted in the main housing;
the arbor is mounted to the main housing by a first bearing system;
the first sleeve is mounted to the main housing by a second bearing system;
the first sleeve is mounted to the secondary housing by a third bearing system; and
the second sleeve is mounted to the carrier means by a fourth bearing system.
